(19) United States
(12) Patent Application Publication
(10) Pub. No.: US 2006/0113454 A1
(43) Pub. Date: Jun. 1, 2006

(54) Rapid fastening multi positioning finger saving frame hanger

(76) Inventor: Paul Stephen Douglas, Bandon, OR (US)

Correspondence Address: PAUL STEPHEN DOUGLAS, 54833 ROSA ROAD, BANDON, OR, 97411, US

(21) Appl. No.: 11/000,598

(22) Filed: Nov. 30, 2004

(51) Int. Cl. B60R 1/02

(52) U.S. Cl. 248/477

(57) ABSTRACT

An rapid fastening multi positioning finger saving frame hanger for use in horizontal and vertical orientation and incorporating a wire or cord like securing feature as well as other desirable features for the holding and securing of the hanger to an object for hanging and including stapler, brad, screw or peg like locating areas for use of rapid fastening methods along with finger saving features for keeping fingers safe while striking a fastener I.E a nail or brad and or incorporating a wave like feature providing hanging, side to side locating, and exact positioning. Likely best produced using materials of the plastics family and which incorporation of some or all it's features provides an reversible, ultimate, universal in nature frame hanger and or multiple choice of related hangers including having areas of esthetics and other design, adhesive means, designer colors and other.

A frame hanger for use of hanging a frame or object and more specifically a picture, mirror, panel or other and as normally used on the object itself rather than on a wall. Incorporating a fastening area whose purpose is for accommodation of a peg like, screw like or staple like fastener for the purpose of rapidly securing of said hanger to the object and with automatic locating features for guidance of the fastener itself.

Incorporating also into said hanger itself automatic peg like threaded or other type fastener holding features whose purpose is for relocation of fingers to a safe area before striking or turning the fastener.

Incorporation a of a unique holding feature for a wire or cord like material enabling rapid securing of same in preparation for hanging an object.

Incorporating a multi functioning device for hanging, side to side locating, centering, and exactly positioning the item being hung.

With or without an adhesive means as an added or alternate means of securing or where use of other means of securing said hanger to the object of choice is not desired or non existent I.E. metal, glass, card, plastics etc. and along with raised or depressed areas which use is for mainly esthetic purposes.

### CROSS REFERENCE TO RELATED APPLICATIONS

No reference to any prior application.

### STATEMENT REGARDING FEDERALLY SPONSERED RESEARCH OR DEVELOPMENT

Not applicable.

### REFERENCE TO SEQUENCE LISTING, A TABLE, OR A COMPUTER PROGRAM LISTING COMPACT DISK APPENDIX.

Not applicable.

### BACKGROUND OF THE INVENTION

This invention relates to frame hanging devices and specifically to a rapid fastening multi positioning finger saving frame hanger which in my investigation of 238 patents I found no prior art relating to hanging devices of various application of a nature so as to be of a truly universal application also being unlike those I am submitting with this patent application, however a list is included of my findings as follows: d 281 144, U.S. Pat. No. 4,566,665, d 284 349,d 496 850, U.S. Pat. No. 4,637,583, r e31 799, U.S. Pat. Nos. 4,309,017, 3,965,600, 5,112,022, 5,267,719, 5,303,895, 5,365,682, 5,437,428, 5,454,542, 5,931,439, 5,947,438, 6,062,525, 6,322,039, 6,540,207, 6,609,693, 6,651,948, 6,719,260, my claims are for the remedy and replacement of old, unsatisfactory, inadequate and or non existing frame hanging methods in use today and who's specific purpose is in the hanging of pictures, mirrors, panels, etc. rather than for use on a wall itself. The universally used and normally horizontal hanging methods still in use today consists of an very thin stamped flat metal device raised in the middle for a distance there along accommodating the teeth area and which device is stamped with holes in place of such large nature as to be to thin for nail holding and supplied with nails almost impossible to hold due to their short length and which must be held with fingers too large whether possessed by adult or child for striking with a hammer like device to secure so that aggravation is always caused as well as often hurt fingers and along with sometimes profanity. My invention completely remedies all areas of these shortcomings .

The universally used wire, cable, cord etc. fastening method in use today consists almost entirely of eye screws which are while being inexpensive as purchased are however laborious time consuming in securing and thus making them ultimately very expensive in today's world and which are secured by first drilling holes as a pilot for the eye screw's threads and thence positioning screws almost always to short to hold into holes and tapping with a hammer to start their threads which is aggravating in itself after which they are turned with thumb and finger as far as possible and then further turned with use of pliers so as to set it's final depth and thence finally securing wire etc, to the eye configuration of the screw which is very easy causing you to relax again

### BACKGROUND OF THE INVENTION

The rapid fastening multi positioning finger saving frame hanger I am seeking patent for addresses all known hanging problems and causes no tension which should be a patent in itself and with incorporation of some or all it's features into my rapid fastening hanger replaces long outdated methods and is superior in nature than anything available today. It can be used in multiple positions of horizontal, vertical or between and used with only some of the claimed features while at the same time utilizing nail holding and or staple, brad or screw holding and locating for use in rapid fastening along with other features, a large variety of hangers may be made. See brief description of the several views of the drawings and the drawings themselves.

This is a sorely needed frame hanger in all it's features and should become a hanger choice for it's users whether household or commercial and lending itself to the plastics family makes it very cost effective for manufacturing, insures no more rust marks on the users walls and due to possibilities of incorporating some of it's features or not or all of them together, a highly desirable truly universal hanging method can be made for use in any given related application while still benefiting by use of it's other retained features.

There exists today a great need of a simple efficient method for a frame hanger that does not frustrate nor irritate it's users, this invention with it's combined features addresses that need in providing a simple yet very practical, easy to use and whose production is of a very cost effective nature.

Further object and advantages of my invention will become apparent from a consideration of the drawings and other description and it will be readily seen and appreciated in reviewing it's broad scope that numerous omissions, addition and or changes made be made in such an embodiment without departing from the nature and spirit of the invention.

### BRIEF SUMMARY OF THE INVENTION

Accordingly the object of my invention is as follows. One of the hangers major advantages is incorporation of it's rapid fastening methods overcoming old, aggravating and inherently slow methods still in wide use today. It incorporates rapid securing by provision of areas for universal use in it's fastening I. E. staple, nail, screw etc and completely replacing other outdated, slow securing methods in use today. It further provides a safe method of holding fasteners which to date have been hand held methods with very short nails causing hurt fingers, aggravation and sometimes profanity to accomplish a task that should be enjoyable for all. Adding further to the pleasure and ease of use are features for attaching a wire or cord replacing entirely the most widely used methods for hanging today even in commercial application using almost entirely eye screws which in securing for acceptance of the wire etc the user must first drill holes as a pilot for the eye screws and thereafter hold with thumb and finger the eye screw almost always to short for holding then tap with a hammer to start the threads {an irritating task in itself} after which the thumb and finger are then used to turn the eye screw until finally pliers are requires for it's final seating and thus also finally completing preparation for attaching the wire {the only enjoyable part of the process}. This one new feature of the hanger I am seeking patent for is in itself very desirable in it's ability to accommodate almost instant securing of the wire, cord etc adding greatly to the hangers universality and with one or more of it's simple variations completely replaces old out of date methods, there for making obsolete the methods in use today.

The inclusion of a device wave like in nature and for the purpose of hanging, centering, side to side adjusting and exactly locating and where used in conjunction with some or all the hangers other features adds very rapid fastening capabilities especially when also incorporating other of the rapid fastening features as set out herein and thus also replacing methods widely used today with old and out of date type hangers of a horizontal orientation.

Also inclusion or not and enhancing universality of the hanger is an adhesive means for use where other fastening methods are not desirable or cannot be attained I.E. metal, plastic, glass etc.

inclusion of raised areas having some use in strengthening are mainly for esthetics means.

The object of this frame hanger is for ease of use, safety of fingers, at the same time using very rapid application methods for accomplishing a task that is user friendly but to date have been only maker friendly. Prior art which may be suitable for one specific purpose, would not be suitable for the purposes of the invention as set out herein evidence of which can be seen by a thorough search of the 238 listed patents of which 22 are more specifically used for picture frame, frame hanging or hanger or hanging apparatuses were searched .

### BRIEF DESCRIPTION OF SEVERAL VIEWS OF THE DRAWINGS

FIG. 1A Orthographic top view depicting one variation of the hanger and having both horizontal and vertical application.

FIG. 1B Orthographic front view depicting one variation of the formed passageway for retention of a cord like substance, detail 1 and of a very thin web for nail or screw holding as at detail 2.

FIG. 1C Orthographic end view depicting one variation of the shape of the horizontal locating feature with an angled surface for ease of locating onto a wall fixture. Detail 3.

FIG. 1D Orthographic top view of a variation depicting one possible actual overall size of the hanger.

FIG. 1E Isometric top view of a variation depicting use of an area for guiding a fastener holding device and for exactly locating same. Detail 4. A raised configuration for added strength and more especially for esthetic purposes. Detail 5.

FIG. 1F Isometric bottom view depicting one of many possible variations of a passage way for retention of a cord like substance for use normally in vertical orientation. Detail 6.

FIG. 2G Orthographic view depicting especially an area for guidance of a fastener holding device for non exact locating so as to be universal in nature having stops on only two sides. Detail 7, which areas are also skewed for purpose of moving the fastening area closer to the retention of the apparatuses.

FIG. 2H Isometric view depicting a variation using the cord like retention feature and with a monolithically formed puncture web whose use is for fastener holding purpose of which is for keeping fingers from harm. Detail 8.

FIG. 2I Isometric view depicting a variation using the cord like retention feature with provision for fastener application areas without exact locating, without esthetic features and without horizontal locating feature being for use normally in a vertical position. Details 9 and 10.

FIG. 2J Isometric view depicting a variation using a horizontal feature and with fastener locating area and with esthetic features without cord like retention.

FIG. 2K Isometric view depicting a variation having it's fastener retention area on the same plain as the center portion and with puncture web or diaphragm which in this case are provided especially for use in screw holding. Detail 11.

### DETAILED DESCRIPTION OF THE INVENTION

A rapid fastening multi positioning finger saving frame hanger which can be made from a variety or combination of materials and incorporating various methods. It is likely best made of materials related to the plastics family of sufficient strength so as to meet it's strength requirements as determined by the individual maker.

It is further best monolithically produced as a unit incorporating some or all of it's features I. E. stapler locating, without nail holding or with both. See drawings for some of it's many variations. A consideration would be at the makers requirements for a specific need I. E. one version for commercial use, another for a different particular purpose.

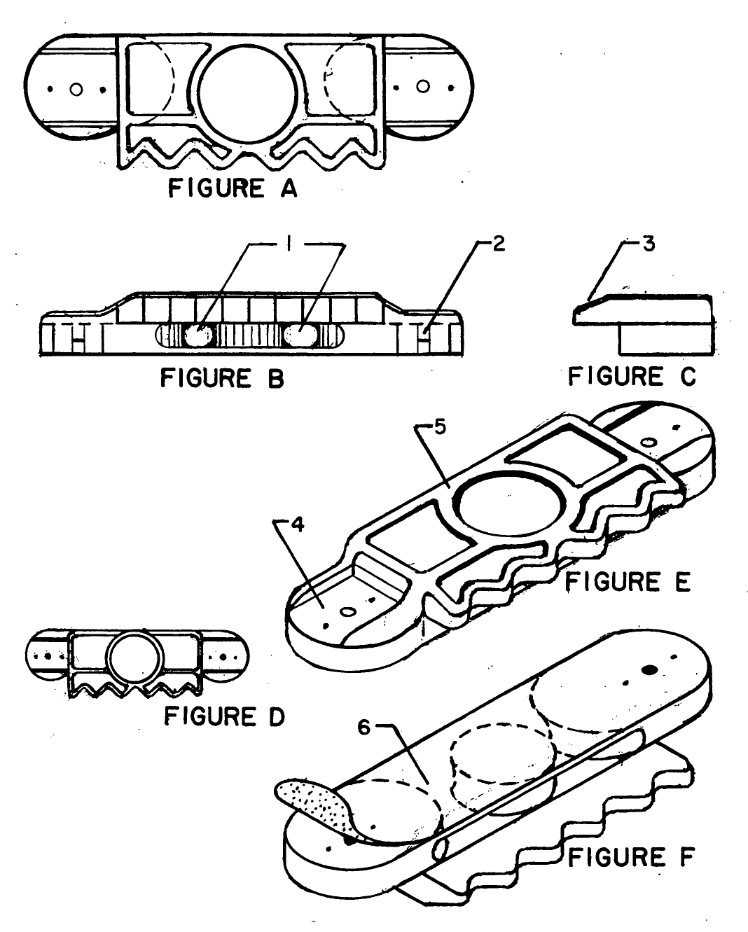

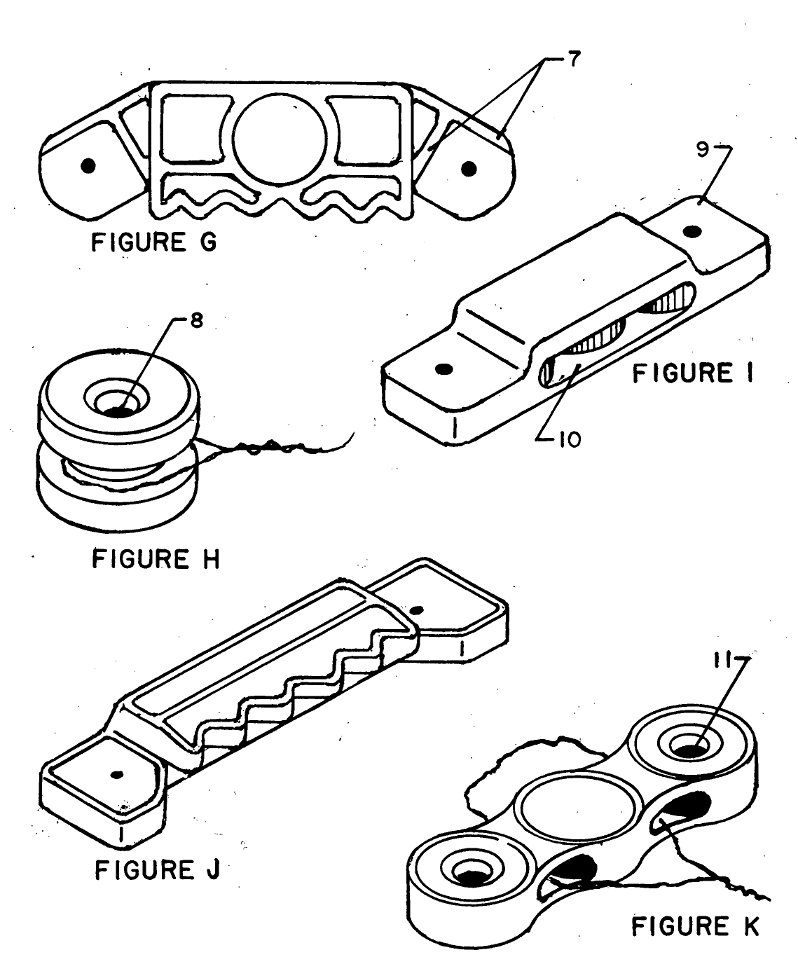

Various thickness and shape lend themselves more readily to some applications than do others I. E. a thicker configuration lending itself particularly to a countersunk hole formation for use of a fastener such as a screw. See page 2, figures h and k, and details 8 and 11. Two considerations for the forming of the nail or screw holding feature for keeping fingers from harms way while striking or turning the fastener of choice could be made having the hole forming pins of the molding die lack the forming of a completely thru hole by a thickness so as to leave a thin web or diaphragm which becomes a tiny retaining flap when punctured as the fastener is pushed into it's location thus providing a simple yet reliable holding means. A retention hole may also be formed so as to be very close in diameter to the fasteners diameter wherein as the fastener is pushed into place a snug fastener to hole relationship is accomplished insuring secure retention of the fastener. See FIG. 1b, detail 2 and figure h and k, details 8 and 11. Because of the hangers thickness whether at the same elevation or not of the hangers top surface, various holding means can be implicated.

The hangers embodiment can incorporate a passageway for the retention and securing of a wire or cord like substance whose use is for the purpose of hanging an object which can be made in a variety of ways as the maker desires. It is best produced as a monolithically embodied unit and being formed rather than drilled or otherwise and likely with use of dies forming a passageway whether hole, holes slot like, spool like or other thus producing a configuration of a sort so as to allow a cord like substance to be passed thru or around in one direction and thence turned and passed back thru or around in a reverse direction and thence secured by clamping, twisting, tying or other method. See figure b detail 1, figure f detail 6, figure h detail 8, and figure k detail 11 for a sampling of the many configurations possible. The main consideration here is the retention and securing of the cord like substance thus providing a rapid means of fastening. This feature if used without the wave like feature used in horizontal orientation would lend to the hangers use in a normally vertical orientation although due to it's configuration orientation is of little concern. See figure h detail 8, FIG. I detail 9 and figure k detail 11.

A receiving or retention area for a staple, brad, screw or other fastener whether incorporated at the same or a different level on the embodiment is for a purpose of incorporating a means of rapid, secure and safe fastening capabilities while also providing a substantial time saving advantage. It may or not be made so as to provide precise locating of a device used for holding and securing of a fastener whether driven or turned. Examples of a variety are seen by a study of the drawings and especially at figure e detail 4, figure g detail 7, FIG. I detail 9, figure k detail 11. As can further be seen the area provided can be made with one, two, three, all or no locating sides and either of a raised, depressed or at the same level on the embodiment so as to provide a means for a precise guide such as a ¼″ crown staple, brad fastener or other. Samples of a few of the various applications are shown in the drawings. A pad or area of any other shape or size may also be utilized as desired by it's maker.

Also incorporated into and as a part of or not the hangers embodiment is a wave like, teeth like or other configuration of a sort as to make the hanger for use in an normally horizontal orientation and whose specific nature is for hanging, side to side locating and exactly positioning the object of choice being hung and should be made in such a manner as to provide space of a distance from a wall as well as a space or distance above the figurations deepest point so as to allow clearance of a nail, screw head or other device set into a wall as normally used for hanging. See especially figure f, g and j. It's use further adds to the hangers multi positioning capabilities and combined with the hangers other features, complete universality with rapid locating are achieved.

Addition of adhesive means for the purpose of rapidly securing the hanger to objects not readily lending themselves to other means of fastening I. E. ,metal, plastic, glass etc adds further to the hangers universality.

The raised areas in the various drawings serve several purposes I. E. added strength, esthetics as well as provision of a space between the head or top of the fastener of choice an the wall surface preventing rust marks often found with old methods of hanging.

While the above descriptions contain many specificities, these should not be construed as limitations as to the scope of the invention but rather as an exemplification of the preferred embodiment thereof. Many other variations are possible as can be readily seen from the sampling as set out in the drawings.

Accordingly the scope of the invention should be determined not by the embodiments illustrated, but by the appended claims and their legal equivalents.

1. A unitary frame hanging device having a length with lateral edges extending there along, the adjacent edges of which have a fastening area and equipped with a hole or holes to facilitate attachment.

2. A unitary frame hanging device having a length with lateral edges extending there along, adjacent edges having a portion equipped with an area and hole or holes to facilitate attachment and with an integrally formed central wire or cord like guide.

3. A unitary frame hanging device having a length with lateral edges extending there along, the adjacent edges of which have a fastening area and or equipped with a hole or holes to facilitate attachment and an integrally formed wire or cord like guide along with a monolithically formed teeth like configuration and being universal in nature.

4. A unitary frame hanging device of claim 1 wherein a portion is equipped with a hole or holes to facilitate attachment and having an integrally formed web or diaphram therein.

5. A unitary frame hanging device of claim 1 wherein an integral area whether raised or depressed in nature is incorporated into it's embodiment whose purpose is provided as a means for rapid securing of a fastener.

6. A unitary frame hanging device of claim 1 wherein is incorporated an area as part of it's embodiment as a stapler or brad guidance means for securing said hanger to an object.

7. A unitary frame hanging device of claim 1 wherein thickness of said device can be varied so as to provide for differing type fasteners.

8. A unitary frame hanging device of claim 1 wherein it's shape may be varied so as to facilitate it's application in fastening to various shape and size objects.

9. A unitary frame hanging device of claim 2 having a thickness such as to provide for a passageway or ways so as to facilitate retention and securing of a cord like substance.

10. A unitary frame hanging device of claim 2 wherein is incorporated a spool like, peg like, hole, holes or other passageway for retention of a cord like substance while at the same time incorporating a fastener retention area and being monolithically formed in nature.

11. A unitary frame hanging device of claim 2 for use in a normally vertical orientation being spool like in nature for retention and securing of a cord like substance while at the same time retaining a rapid fastening, finger saving capabilities.

12. A unitary frame hanging device of claims 2 and 3 wherein being monolithically formed in nature and having horizontal and vertical application and with incorporation of an area whose purpose is for holding a fastener.

13. A unitary frame hanging device of claim 3 having a configuration wave like, teeth like or straight in nature and having or not an angled top surface for a distance to enhance locating of said hanger onto an object.

14. A unitary frame hanging device of claims 1, 2 and 3 having incorporated into it's embodiment a raised or depressed configuration of a sort so as to add strength and or aesthetics.

15. A unitary frame hanging device of claim 3 being of a monolithically formed nature and having any of it's features incorporated at a level or size and relation to it's overall embodiment.

16. A unitary frame hanging device of claim 3 being universal in nature of a sort so as to incorporate any or all it's claimed features while at the same time being monolithically formed.

17. A unitary frame hanging device of claim 3 having some or all it's features and at the same time incorporating rapid fastening and or finger saving and or being universal in nature
